(19) United States
(12) Patent Application Publication
(10) Pub. No.: US 2022/0043993 A1
(43) Pub. Date: Feb. 10, 2022

(54) ULTRASONIC SENSOR WITH RECEIVE BEAMFORMING

(71) Applicant: TDK CORPORATION, Tokyo (JP)

(72) Inventors: Xiaoyue JIANG, San Jose, CA (US); Mamdouh YANNI, Brentwood, CA (US); Mei-Lin CHAN, Milpitas, CA (US); Cathy LEE, Palo Alto, CA (US); Peter George HARTWELL, Menlo Park, CA (US)

(73) Assignee: TDK CORPORATION, Tokyo (JP)

(21) Appl. No.: 17/396,301

(22) Filed: Aug. 6, 2021

Related U.S. Application Data
(60) Provisional application No. 63/063,148, filed on Aug. 7, 2020.

(51) Int. Cl. G06K 9/00; G01S 15/89; B06B 1/06; G10K 11/34

(52) U.S. Cl. CPC G06K 9/0002; G01S 15/8915; B06B 2201/55; G10K 11/346; B06B 1/0629

(57) ABSTRACT

In a method for receive beamforming using an array of ultrasonic transducers, a plurality of array positions comprising pluralities of ultrasonic transducers of the array of ultrasonic transducers is defined. A pixel capture operation is performed at each array position of the plurality of array positions. The pixel capture operation includes transmitting ultrasonic signals using a transmit beam pattern comprising ultrasonic transducers of the array of ultrasonic transducers, the transmit beam pattern for forming an ultrasonic beam toward a region of interest, and receiving reflected ultrasonic signals using a receive beam pattern comprising at least one ultrasonic transducer of the array of ultrasonic transducers. Received reflected ultrasonic signals are combined for a plurality of array positions overlapping the region of interest in a receive beamforming operation to generate a pixel for a reference array position of the plurality of array positions.

### RELATED APPLICATIONS

This application claims priority to and the benefit of co-pending U.S. Patent Provisional Patent Application 63/063,148, filed on Aug. 7, 2020, entitled “ULTRASONIC SENSOR WITH RECEIVE BEAMFORMING,” by Jiang et al., having Attorney Docket No. IVS-970-PR, and assigned to the assignee of the present application, which is incorporated herein by reference in its entirety.

### BACKGROUND

Fingerprint sensors have become ubiquitous in mobile devices as well as other applications for authenticating a user's identity. They provide a fast and convenient way for the user to unlock a device, provide authentication for payments, etc. Current fingerprint sensors are typically area sensors that obtain a two-dimensional image of the user's finger area presented to the sensor. Different technologies can be used to image the finger such as capacitive, ultrasound, and optical sensing. Once an image is obtained, that image is processed by a matcher to extract features and to compare against stored images to authenticate the user. As such, accuracy of captured images is essential to the performance of image matching for user authentication.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1A is a diagram illustrating a piezoelectric micromachined ultrasonic transducer (PMUT) device having a center pinned membrane, according to some embodiments.

FIG. 1B is a diagram illustrating a PMUT device having an unpinned membrane, according to some embodiments.

FIG. 2 is a diagram illustrating an example of membrane movement during activation of a PMUT device having a center pinned membrane, according to some embodiments.

FIG. 3 is a top view of the PMUT device of FIG. 1A, according to some embodiments.

FIG. 4 is a simulated map illustrating maximum vertical displacement of the membrane of the PMUT device shown in FIGS. 1A, 2, and 3, according to some embodiments.

FIG. 5 is a top view of an example PMUT device having a circular shape, according to some embodiments.

FIG. 6 illustrates an example array of square-shaped PMUT devices, according to some embodiments.

FIG. 7A illustrates an example fingerprint sensor, in accordance with various embodiments.

FIG. 7B illustrates example concurrent operation of pixel capture for a multiple array positions in a two-dimensional array of ultrasonic transducers, according to some embodiments.

FIG. 8 shows an example two-dimensional array of ultrasonic transducers, according to embodiments

FIG. 9 shows an example 9×9 beamforming pattern, according to an embodiment.

FIG. 10 shows a side view of an example of two sequential signal capture operations, according to embodiments.

FIGS. 11A and 11B show examples of beamforming patterns with different transmit beamforming patterns, according to embodiments.

FIG. 12 shows a side view of an example of two sequential signal capture operations in which the transmit beamforming patterns is different for each signal capture operation, according to embodiments

FIGS. 13A and 13B show examples of beamforming patterns with different transmit beamforming patterns with different receive patterns, according to embodiments.

FIG. 14 shows a side view of an example of two sequential signal capture operations in which the transmit beamforming patterns and receive patterns are different for each signal capture operation, according to embodiments.

FIG. 15A show examples of beamforming patterns with different receive patterns, according to embodiments.

FIG. 15B shows example plots of signals received from an example line phantom target using the different receive transducers of FIG. 15A, according to embodiments.

FIG. 16 illustrates a flow diagram of an example process for receive beamforming using an array of ultrasonic transducers where one pixel capture operation over the array is performed, according to embodiments.

FIG. 17 illustrates a flow diagram of an example process for receive beamforming using an array of ultrasonic transducers where a plurality of pixel capture operations over the array is performed, where the plurality of pixel capture operations is performed at each array position changing at least one of the transmit beam pattern and the receive beam pattern prior to proceeding to a subsequent array position, according to embodiments.

FIG. 18 illustrates a flow diagram of an example process for receive beamforming using an array of ultrasonic transducers where one pixel capture operation over the array is performed, wherein each pixel capture operation is performed over the array of ultrasonic transducers prior to changing at least one of the transmit beam pattern and the receive beam pattern, according to embodiments.

### DESCRIPTION OF EMBODIMENTS

The following Description of Embodiments is merely provided by way of example and not of limitation. Furthermore, there is no intention to be bound by any expressed or implied theory presented in the preceding background or in the following Description of Embodiments.

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Some portions of the detailed descriptions which follow are presented in terms of procedures, logic blocks, processing and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of acoustic (e.g., ultrasonic) signals capable of being transmitted and received by an electronic device and/or electrical or magnetic signals capable of being stored, transferred, combined, compared, and otherwise manipulated in an electrical device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “defining,” “performing,” “transmitting,” “combining,” “accounting,” “capturing,” “generating,” “determining,” “receiving,” “comparing,” “selecting,” “acquiring,” “providing,” “proceeding,” “controlling,” “changing,” or the like, refer to the actions and processes of an electronic device such as an electrical device.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example fingerprint sensing system and/or mobile electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

It is to be noted that, as used in this specification and the appended claims, the singular forms “a,” “an,” and “the” include plural referents unless the context clearly dictates otherwise. Also, any reference herein to “top”, “bottom”, “upper”, “lower”, “up”, “down”, “front”, “back”, “first”, “second”, “left” or “right” is not intended to be a limitation herein. It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples. Also, the examples may be used in combination with each other.

### Overview of Discussion

Discussion begins with a description of an example piezoelectric micromachined ultrasonic transducer (PMUT), in accordance with various embodiments. Example sensors including arrays of ultrasonic transducers are then described. Examples of receive beamforming at an ultrasonic transducer are then described. Example operations for performing receive beamforming at an ultrasonic transducer then described.

Ultrasonic sensors, such as ultrasonic fingerprint sensors, may utilize beamforming for increased performance. The beam forming can be divided into transmit beamforming and receive beamforming. In transmit beamforming, the sensor focusses the ultrasonic energy on a certain location/direction during the transmit phase. In receive beamforming, the sensor focusses the receive direction to select the origin of the received signal. As utilized herein, and in accordance with the described embodiments, receive beamforming applies an adjusted delay and an optimized amplitude weight to the output of each PMUT sensor, and then sums the resulting signals (waveforms captured by the individual sensors add constructively), hence maximizing the PMUT array sensitivity. This enables to select signals from the direction/region of interest, and can also be used to avoid or minimize interferences. Furthermore, signals and noise arriving from other direction can be suppressed.

Embodiments described herein provide methods and devices for performing receive beamforming using an array of ultrasonic transducers. A plurality of array positions comprising pluralities of ultrasonic transducers of the array of ultrasonic transducers is defined, the plurality of array positions each comprising a portion of ultrasonic transducers of the array of ultrasonic transducers.

A pixel capture operation is performed at each array position of the plurality of array positions. Ultrasonic signals are transmitted using a transmit beam pattern comprising ultrasonic transducers of the array of ultrasonic transducers, wherein at least some ultrasonic transducers of the transmit beam pattern are phase delayed with respect to other ultrasonic transducers of the transmit beam pattern, the transmit beam pattern for forming an ultrasonic beam toward a region of interest. Reflected ultrasonic signals are received using a receive beam pattern comprising at least one ultrasonic transducer of the array of ultrasonic transducers, wherein the transmit beam pattern comprises different ultrasonic transducers than the receive beam pattern The received reflected ultrasonic signals are combined for a plurality of array positions overlapping the region of interest in a receive beamforming operation to generate a pixel for a reference array position of the plurality of array positions. In some embodiments, the reference array position is center array position of the plurality of array positions overlapping the region of interest. In some embodiments, the plurality of array positions overlapping the region of interest comprises a plurality of sequential array positions of the pixel capture operation. In some embodiments, an image comprising the pixels at each array position of the plurality of array positions is generated.

In some embodiments, the combining received reflected ultrasonic signals for a plurality of array positions overlapping the region of interest in a receive beamforming operation to generate a pixel for the region of interest includes accounting for a difference in time of flight of the received reflected ultrasonic signals for the plurality of array positions overlapping the region of interest. In some embodiments, the combining received reflected ultrasonic signals for a plurality of array positions overlapping the region of interest in a receive beamforming operation to generate a pixel for the region of interest includes accounting for a difference in phase of the received reflected ultrasonic signals for the plurality of array positions overlapping the region of interest.

In some embodiments, a plurality of pixel capture operations are performed at each array position of the plurality of array positions. In some embodiments, at least one of the transmit beam pattern and the receive beam pattern is changed over the plurality of pixel capture operations at each array position. In some embodiments, ultrasonic transducers of the transmit beam pattern are changed over the plurality of pixel capture operations at each array position. In some embodiments, ultrasonic transducers of the receive beam pattern are changed over the plurality of pixel capture operations at each array position.

In some embodiments, the plurality of pixel capture operations is performed at each array position changing at least one of the transmit beam pattern and the receive beam pattern prior to proceeding to a subsequent array position. In some embodiments, each pixel capture operation is performed over the array of ultrasonic transducers prior to changing at least one of the transmit beam pattern and the receive beam pattern.

### Example Piezoelectric Micromachined Ultrasonic Transducer (PMUT) and Array of PMUTS

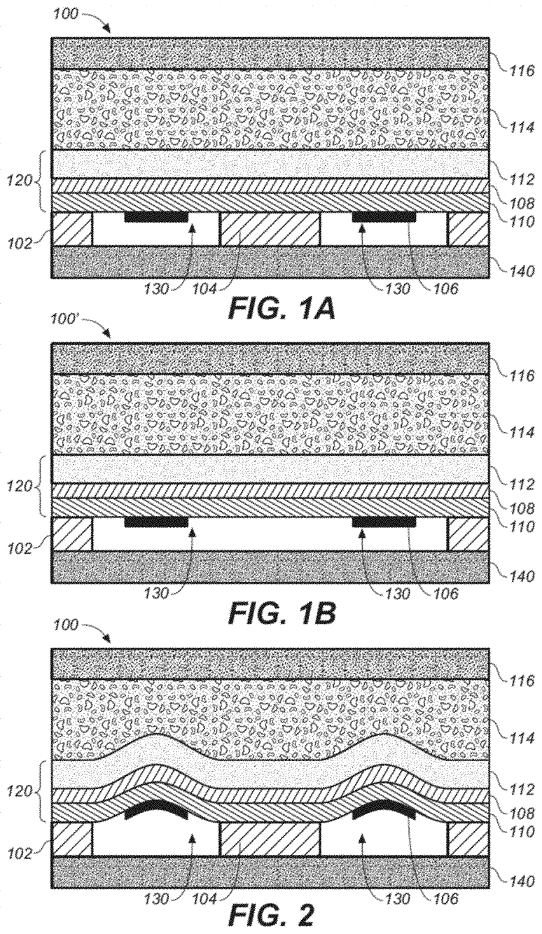

Systems and methods disclosed herein, in one or more aspects provide efficient structures for an acoustic transducer (e.g., a piezoelectric actuated transducer or PMUT). FIG. 1A is a diagram illustrating a PMUT device 100 having a center pinned membrane, according to some embodiments. PMUT device 100 includes an interior pinned membrane 120 positioned over a substrate 140 to define a cavity 130. In one embodiment, membrane 120 is attached both to a surrounding edge support 102 and interior support 104. In one embodiment, edge support 102 is connected to an electric potential. Edge support 102 and interior support 104 may be made of electrically conducting materials, such as and without limitation, aluminum, molybdenum, or titanium. Edge support 102 and interior support 104 may also be made of dielectric materials, such as silicon dioxide, silicon nitride or aluminum oxide that have electrical connections the sides or in vias through edge support 102 or interior support 104, electrically coupling lower electrode 106 to electrical wiring in substrate 140.

In one embodiment, both edge support 102 and interior support 104 are attached to a substrate 140. In various embodiments, substrate 140 may include at least one of, and without limitation, silicon or silicon nitride. It should be appreciated that substrate 140 may include electrical wirings and connection, such as aluminum or copper. In one embodiment, substrate 140 includes a CMOS logic wafer bonded to edge support 102 and interior support 104. In one embodiment, the membrane 120 comprises multiple layers. In an example embodiment, the membrane 120 includes lower electrode 106, piezoelectric layer 110, and upper electrode 108, where lower electrode 106 and upper electrode 108 are coupled to opposing sides of piezoelectric layer 110. As shown, lower electrode 106 is coupled to a lower surface of piezoelectric layer 110 and upper electrode 108 is coupled to an upper surface of piezoelectric layer 110. It should be appreciated that, in various embodiments, PMUT device 100 is a microelectromechanical (MEMS) device.

In one embodiment, membrane 120 also includes a mechanical support layer 112 (e.g., stiffening layer) to mechanically stiffen the layers. In various embodiments, mechanical support layer 112 may include at least one of, and without limitation, silicon, silicon oxide, silicon nitride, aluminum, molybdenum, titanium, etc. In one embodiment, PMUT device 100 also includes an acoustic coupling layer 114 above membrane 120 for supporting transmission of acoustic signals. It should be appreciated that acoustic coupling layer can include air, liquid, gel-like materials, or other materials for supporting transmission of acoustic signals. In one embodiment, PMUT device 100 also includes platen layer 116 above acoustic coupling layer 114 for containing acoustic coupling layer 114 and providing a contact surface for a finger or other sensed object with PMUT device 100. It should be appreciated that, in various embodiments, acoustic coupling layer 114 provides a contact surface, such that platen layer 116 is optional. Moreover, it should be appreciated that acoustic coupling layer 114 and/or platen layer 116 may be included with or used in conjunction with multiple PMUT devices. For example, an array of PMUT devices may be coupled with a single acoustic coupling layer 114 and/or platen layer 116.

FIG. 1B is identical to FIG. 1A in every way, except that the PMUT device 100′ of FIG. 1B omits the interior support 104 and thus membrane 120 is not pinned (e.g., is “unpinned”). There may be instances in which an unpinned membrane 120 is desired. However, in other instances, a pinned membrane 120 may be employed.

FIG. 2 is a diagram illustrating an example of membrane movement during activation of pinned PMUT device 100, according to some embodiments. As illustrated with respect to FIG. 2, in operation, responsive to an object proximate platen layer 116, the electrodes 106 and 108 deliver a high frequency electric charge to the piezoelectric layer 110, causing those portions of the membrane 120 not pinned to the surrounding edge support 102 or interior support 104 to be displaced upward into the acoustic coupling layer 114. This generates a pressure wave that can be used for signal probing of the object. Return echoes can be detected as pressure waves causing movement of the membrane, with compression of the piezoelectric material in the membrane causing an electrical signal proportional to amplitude of the pressure wave.

The described PMUT device 100 can be used with almost any electrical device that converts a pressure wave into mechanical vibrations and/or electrical signals. In one aspect, the PMUT device 100 can comprise an acoustic sensing element (e.g., a piezoelectric element) that generates and senses ultrasonic sound waves. An object in a path of the generated sound waves can create a disturbance (e.g., changes in frequency or phase, reflection signal, echoes, etc.) that can then be sensed. The interference can be analyzed to determine physical parameters such as (but not limited to) distance, density and/or speed of the object. As an example, the PMUT device 100 can be utilized in various applications, such as, but not limited to, fingerprint or physiologic sensors suitable for wireless devices, industrial systems, automotive systems, robotics, telecommunications, security, medical devices, etc. For example, the PMUT device 100 can be part of a sensor array comprising a plurality of ultrasonic transducers deposited on a wafer, along with various logic, control and communication electronics. A sensor array may comprise homogenous or identical PMUT devices 100, or a number of different or heterogonous device structures.

In various embodiments, the PMUT device 100 employs a piezoelectric layer 110, comprised of materials such as, but not limited to, aluminum nitride (AlN), lead zirconate titanate (PZT), quartz, polyvinylidene fluoride (PVDF), and/or zinc oxide, to facilitate both acoustic signal production and sensing. The piezoelectric layer 110 can generate electric charges under mechanical stress and conversely experience a mechanical strain in the presence of an electric field. For example, the piezoelectric layer 110 can sense mechanical vibrations caused by an ultrasonic signal and produce an electrical charge at the frequency (e.g., ultrasonic frequency) of the vibrations. Additionally, the piezoelectric layer 110 can generate an ultrasonic wave by vibrating in an oscillatory fashion that might be at the same frequency (e.g., ultrasonic frequency) as an input current generated by an alternating current (AC) voltage applied across the piezoelectric layer 110. It should be appreciated that the piezoelectric layer 110 can include almost any material (or combination of materials) that exhibits piezoelectric properties, such that the structure of the material does not have a center of symmetry and a tensile or compressive stress applied to the material alters the separation between positive and negative charge sites in a cell causing a polarization at the surface of the material. The polarization is directly proportional to the applied stress and is direction dependent so that compressive and tensile stresses results in electric fields of opposite polarizations.

Further, the PMUT device 100 comprises electrodes 106 and 108 that supply and/or collect the electrical charge to/from the piezoelectric layer 110. It should be appreciated that electrodes 106 and 108 can be continuous and/or patterned electrodes (e.g., in a continuous layer and/or a patterned layer). For example, as illustrated, electrode 106 is a patterned electrode and electrode 108 is a continuous electrode. As an example, electrodes 106 and 108 can be comprised of almost any metal layers, such as, but not limited to, aluminum (Al)/titanium (Ti), molybdenum (Mo), etc., which are coupled with an on opposing sides of the piezoelectric layer 110.

According to an embodiment, the acoustic impedance of acoustic coupling layer 114 is selected to be similar to the acoustic impedance of the platen layer 116, such that the acoustic wave is efficiently propagated to/from the membrane 120 through acoustic coupling layer 114 and platen layer 116. As an example, the platen layer 116 can comprise various materials having an acoustic impedance in the range between 0.8 to 4 Mega Rayleigh (MRayl), such as, but not limited to, plastic, resin, rubber, Teflon, epoxy, etc. In another example, the platen layer 116 can comprise various materials having a high acoustic impedance (e.g., an acoustic impendence greater than 10 MRayl), such as, but not limited to, glass, aluminum-based alloys, sapphire, etc. Typically, the platen layer 116 can be selected based on an application of the sensor. For instance, in fingerprinting applications, platen layer 116 can have an acoustic impedance that matches (e.g., exactly or approximately) the acoustic impedance of human skin (e.g., 1.6×10⁶ Rayl). Further, in one aspect, the platen layer 116 can further include a thin layer of anti-scratch material. In various embodiments, the anti-scratch layer of the platen layer 116 is less than the wavelength of the acoustic wave that is to be generated and/or sensed to provide minimum interference during propagation of the acoustic wave. As an example, the anti-scratch layer can comprise various hard and scratch-resistant materials (e.g., having a Mohs hardness of over 7 on the Mohs scale), such as, but not limited to sapphire, glass, titanium nitride (TiN), silicon carbide (SiC), diamond, etc. As an example, PMUT device 100 can operate at 20 MHz and accordingly, the wavelength of the acoustic wave propagating through the acoustic coupling layer 114 and platen layer 116 can be 70-150 microns. In this example scenario, insertion loss can be reduced and acoustic wave propagation efficiency can be improved by utilizing an anti-scratch layer having a thickness of 1 micron and the platen layer 116 as a whole having a thickness of 1-2 millimeters. It is noted that the term “anti-scratch material” as used herein relates to a material that is resistant to scratches and/or scratch-proof and provides substantial protection against scratch marks.

In accordance with various embodiments, the PMUT device 100 can include metal layers (e.g., aluminum (Al)/titanium (Ti), molybdenum (Mo), etc.) patterned to form electrode 106 in particular shapes (e.g., ring, circle, square, octagon, hexagon, etc.) that are defined in-plane with the membrane 120. Electrodes can be placed at a maximum strain area of the membrane 120 or placed at close to either or both the surrounding edge support 102 and interior support 104. Furthermore, in one example, electrode 108 can be formed as a continuous layer providing a ground plane in contact with mechanical support layer 112, which can be formed from silicon or other suitable mechanical stiffening material. In still other embodiments, the electrode 106 can be routed along the interior support 104, advantageously reducing parasitic capacitance as compared to routing along the edge support 102.

For example, when actuation voltage is applied to the electrodes, the membrane 120 will deform and move out of plane. The motion then pushes the acoustic coupling layer 114 it is in contact with and an acoustic (ultrasonic) wave is generated. Oftentimes, vacuum is present inside the cavity 130 and therefore damping contributed from the media within the cavity 130 can be ignored. However, the acoustic coupling layer 114 on the other side of the membrane 120 can substantially change the damping of the PMUT device 100. For example, a quality factor greater than 20 can be observed when the PMUT device 100 is operating in air with atmosphere pressure (e.g., acoustic coupling layer 114 is air) and can decrease lower than 2 if the PMUT device 100 is operating in water (e.g., acoustic coupling layer 114 is water).

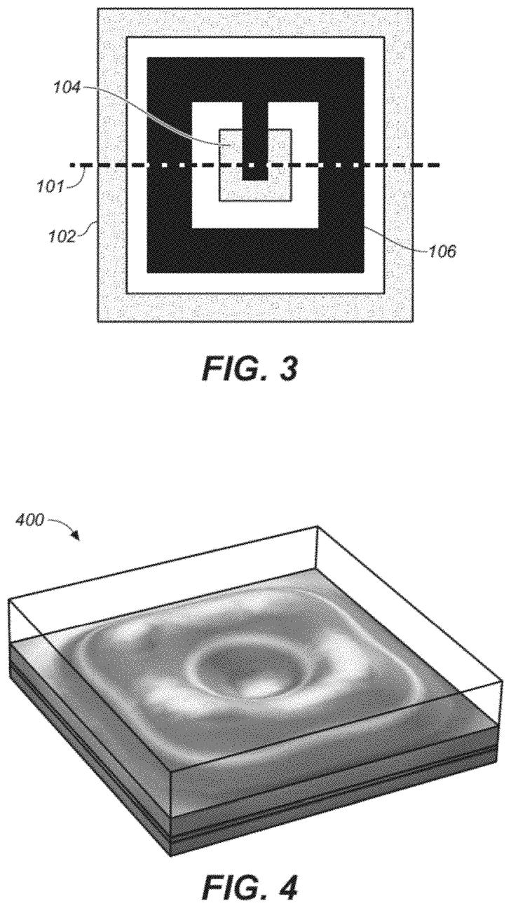

FIG. 3 is a top view of the PMUT device 100 of FIG. 1A having a substantially square shape, which corresponds in part to a cross section along dotted line 101 in FIG. 3. Layout of surrounding edge support 102, interior support 104, and lower electrode 106 are illustrated, with other continuous layers not shown. It should be appreciated that the term “substantially” in “substantially square shape” is intended to convey that a PMUT device 100 is generally square-shaped, with allowances for variations due to manufacturing processes and tolerances, and that slight deviation from a square shape (e.g., rounded corners, slightly wavering lines, deviations from perfectly orthogonal corners or intersections, etc.) may be present in a manufactured device. While a generally square arrangement PMUT device is shown, alternative embodiments including rectangular, hexagon, octagonal, circular, or elliptical are contemplated. In other embodiments, more complex electrode or PMUT device shapes can be used, including irregular and non-symmetric layouts such as chevrons or pentagons for edge support and electrodes.

FIG. 4 is a simulated topographic map 400 illustrating maximum vertical displacement of the membrane 120 of the PMUT device 100 shown in FIGS. 1A-3. As indicated, maximum displacement generally occurs along a center axis of the lower electrode, with corner regions having the greatest displacement. As with the other figures, FIG. 4 is not drawn to scale with the vertical displacement exaggerated for illustrative purposes, and the maximum vertical displacement is a fraction of the horizontal surface area comprising the PMUT device 100. In an example PMUT device 100, maximum vertical displacement may be measured in nanometers, while surface area of an individual PMUT device 100 may be measured in square microns.

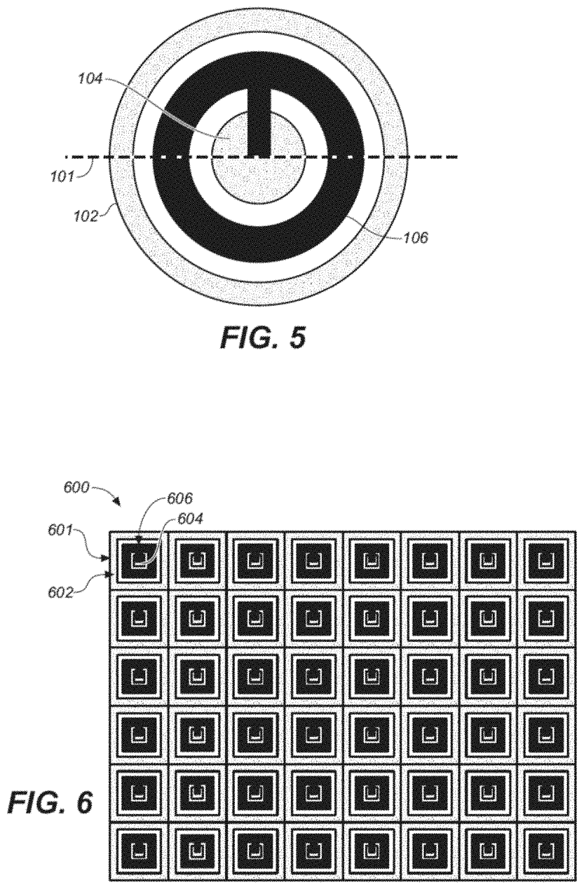

FIG. 5 is a top view of another example of the PMUT device 100 of FIG. 1A having a substantially circular shape, which corresponds in part to a cross section along dotted line 101 in FIG. 5. Layout of surrounding edge support 102, interior support 104, and lower electrode 106 are illustrated, with other continuous layers not shown. It should be appreciated that the term “substantially” in “substantially circular shape” is intended to convey that a PMUT device 100 is generally circle-shaped, with allowances for variations due to manufacturing processes and tolerances, and that slight deviation from a circle shape (e.g., slight deviations on radial distance from center, etc.) may be present in a manufactured device.

FIG. 6 illustrates an example two-dimensional array 600 of square-shaped PMUT devices 601 formed from PMUT devices having a substantially square shape similar to that discussed in conjunction with FIGS. 1A, 1B, 2, and 3. Layout of square surrounding edge support 602, interior support 604, and square-shaped lower electrode 606 surrounding the interior support 604 are illustrated, while other continuous layers are not shown for clarity. As illustrated, array 600 includes columns of square-shaped PMUT devices 601 that are in rows and columns. It should be appreciated that rows or columns of the square-shaped PMUT devices 601 may be offset. Moreover, it should be appreciated that square-shaped PMUT devices 601 may contact each other or be spaced apart. In various embodiments, adjacent square-shaped PMUT devices 601 are electrically isolated. In other embodiments, groups of adjacent square-shaped PMUT devices 601 are electrically connected, where the groups of adjacent square-shaped PMUT devices 601 are electrically isolated.

In operation, during transmission, selected sets of PMUT devices in the two-dimensional array can transmit an acoustic signal (e.g., a short ultrasonic pulse) and during sensing, the set of active PMUT devices in the two-dimensional array can detect an interference of the acoustic signal with an object (in the path of the acoustic wave). The received interference signal (e.g., generated based on reflections, echoes, etc. Of the acoustic signal from the object) can then be analyzed. As an example, an image of the object, a distance of the object from the sensing component, a density of the object, a motion of the object, etc., can all be determined based on comparing a frequency and/or phase of the interference signal with a frequency and/or phase of the acoustic signal. Moreover, results generated can be further analyzed or presented to a user via a display device (not shown).

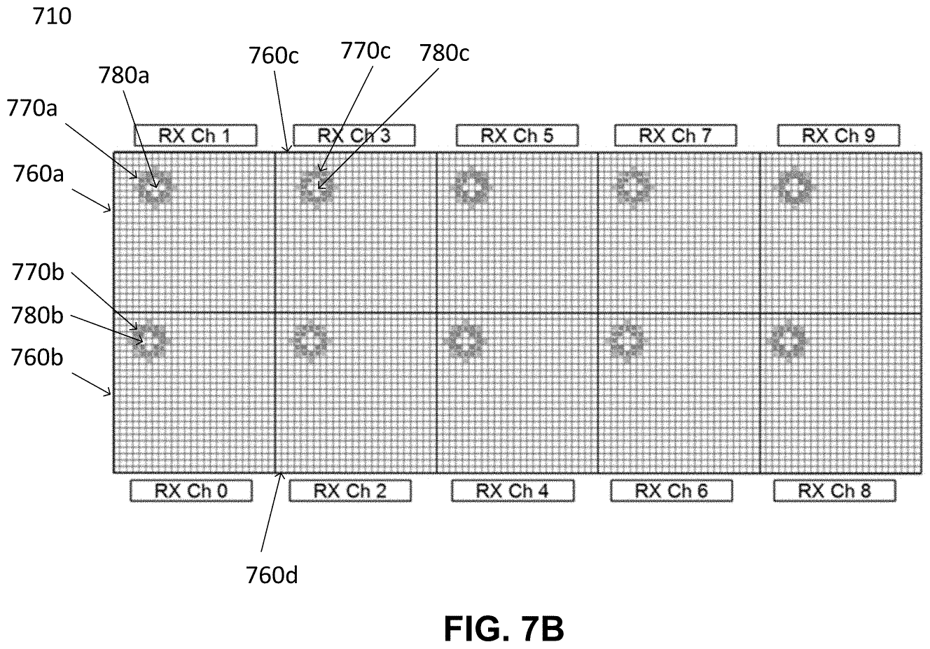

FIG. 7A illustrates an example fingerprint sensor 700, in accordance with various embodiments. In one embodiment, fingerprint sensor 700 includes an array 710 of ultrasonic transducers (e.g.; PMUT devices), a processor 720, and a memory 730. In various embodiments, processor 720 performs certain operations in accordance with instructions stored within memory 730. It should be appreciated that components of fingerprint sensor 700 are examples, and that certain components, such as processor 720 and/or memory 730 may not be located within fingerprint sensor 700. For example, system circuitry of an electronic device including fingerprint sensor 700 may include a processor and/or memory for performing certain operations.

In one embodiment, fingerprint sensor 700 includes processor 720 for performing the pixel capture, where pixel capture is performed using subsets of ultrasonic transducers (e.g., PMUTs) of fingerprint sensor 700. In other embodiments, processor 720 can perform at least some signal analysis, e.g., thresholding, to determine whether an object has interacted with fingerprint sensor 700. In other embodiments, processor 720 can analyze captured pixels and determine whether the object has characteristics of finger, e.g., a pattern resembling the ridge/valley pattern of a fingerprint. In other embodiments, processor 720 can capture an image of the fingerprint and forward it to a processor of system circuitry for further analysis.

While the embodiment of FIG. 7A includes processor 720 and memory 730, as described above, it should be appreciated that various functions of processor 720 and memory 730 may reside in other components of the electronic device within which fingerprint sensor 700 resides (e.g., within always-on circuitry or system circuitry). Moreover, it should be appreciated that processor 720 may be any type of processor for performing any portion of the described functionality (e.g., custom digital logic).

In various embodiments, fingerprint sensor 700 can include ultrasonic transducers (e.g., PMUTs) able to generate and detect acoustic/pressure waves. Examples of PMUT devices and arrays of PMUT devices are described in accordance with FIGS. 1A-6 above. In embodiments, a device includes fingerprint sensor 700 comprised of an array of ultrasonic transducers that can facilitate ultrasonic signal generation and sensing. For example, fingerprint sensor 700 can include a silicon wafer having a two-dimensional (or one-dimensional) array of ultrasonic transducers.

FIG. 7B illustrates example concurrent operation of pixel capture for a multiple array positions in a two-dimensional array 710 of ultrasonic transducers, according to some embodiments. A beamforming pattern is defined for two-dimensional array 710. In the illustrated example, two-dimensional array 710 is 50×125 ultrasonic transducers, separated into ten identical 25×25 segments 760 (four of which are illustrated as sub-blocks 760a-d). When a sequence of activation to generate an ultrasound beam and sensing reflected echoes is completed, the beamforming pattern (e.g., beamforming patterns 770a, 770b, and 770c) is moved according to a pixel capture sequence (e.g., rightward or leftward, or upward and downward), with respect to the two-dimensional array 710 of ultrasonic transducers, and the sequence is repeated until all (or a specified amount) of pixels have been imaged. As the beamforming pattern moves, so does the receive pattern of ultrasonic transducers activated during a receive operation (e.g., receive patterns 780a, 780b, and 780c).

It should be appreciated that any type of pixel capture sequence may be used (e.g., side-to-side, top-to-bottom, random, another predetermined order, row and/or column skipping, etc.) Moreover, it should be appreciated that FIG. 7B illustrates a phase delay pattern that is symmetric about a focal point of the transmitting pixels. Once a beamforming space has been defined to designate which ultrasonic transducers in the beamforming space will be used for transmission of ultrasonic signals (e.g., the beamforming pattern), for receipt of reflected ultrasonic signals (e.g., the receive pattern), or for nothing (remain inactive), the ultrasonic sensor programs the transmit beamforming pattern and receive beamforming pattern into at least one location within the ultrasonic transducer array.

In one embodiment, an array controller (e.g., an array engine, array control logic) and array control shift register logic of the ultrasonic sensor programs this transmit beamforming pattern and receive pattern onto a plurality of locations within the ultrasonic transducer array. For example, with reference to FIG. 7B, the beamforming pattern is programmed at corresponding locations within each of the ten ultrasonic array sub-blocks so that up to ten image pixels can be captured in each transmit/received (TX/RX) operation, one pixel from each of the ten ultrasonic array sub-blocks. Imaging over the entire sensor area is then accomplished by stepping the beamforming patterns over the entire ultrasonic transducer array, transmitting and receiving at each step to capture a corresponding image pixel, where each sub-block corresponds to a segment of the image.

### Example Receive Beamforming at an Ultrasonic Sensor

Embodiments described herein provide methods and systems for segmented image acquisition at a sensor. In some embodiments, the sensor is an ultrasonic sensor. In other embodiments, the sensor is an optical sensor. In other embodiments, the sensor is a capacitive sensor. A plurality of segments of an image are captured concurrently. Pixels of each segment of the plurality of segments are captured according to a pixel capture sequence. The pixel capture sequence for at least one segment of the plurality of segments is a non-progressive sequence for controlling a timing difference between pixel capture for proximate pixels of adjacent segments. An image comprising the plurality of segments is generated.

Conventional imaging sensors capture pixels in a raster scan order, e.g., left-to-right across a row of pixels from top-to-bottom over the scanned area in consecutive order. As the imaging area of a conventional imaging sensors grows, the time required for image acquisition grows as well. To improve image acquisition time, improved imaging sensors in accordance with the described embodiments, such as an ultrasonic fingerprint sensor, provide for parallelization of pixel acquisition. An advantage of segmented image acquisition is that by capturing various segments concurrently the overall time required to capture a complete sensor image is reduced. Concurrent capturing and processing of the image segment enables an increase acquisition and processing time per pixel, while maintaining a constant total image capture time. Reduced image acquisition time may also help increase a framerate when a series of images needs to be captured in sequence. In some embodiments, the parallel pixel acquisition is segmented image acquisition, in which segments of the complete image are captured concurrently (e.g., in parallel), improving the speed of image acquisition. The segments are captured concurrently, while pixels within each segment are captured according to a pixel capture sequence.

During segmented or tiled image acquisition, if an object being imaged moves during the image acquisition, artifacts may be generated at the contiguous boundary between adjacent segments of the image. The artifacts are generated because of the timing differences between the pixels captured at the contiguous boundary. For example, during fingerprint acquisition at an imaging sensor, a ridge pattern on edges of segments might not be aligned, resulting in problems with an image matcher and authentication, impacting performance of the of the fingerprint sensor. Therefore, embodiments described herein seek to reduce boundary artifacts, and as such, increase performance of the sensor.

Embodiments described herein provide a method for determining at least one pixel capture sequence for use in segmented image acquisition of at sensor. Embodiments described herein provide improved image capture during segmented image acquisition by reducing the impact of artifact generation caused by timing differences between edge pixels of adjacent segments. Embodiments described herein provide for segmented image acquisition, where a plurality of segments of the image are captured concurrently. Pixels of each segment are captured according to a pixel capture sequence, such that a timing difference between pixel capture for adjacent edge pixels at the contiguous boundary of adjacent segments is minimized. In one embodiment, at least one pixel capture sequence for segments of an image is determined for minimizing timing differences between adjacent edge pixels of adjacent segments.

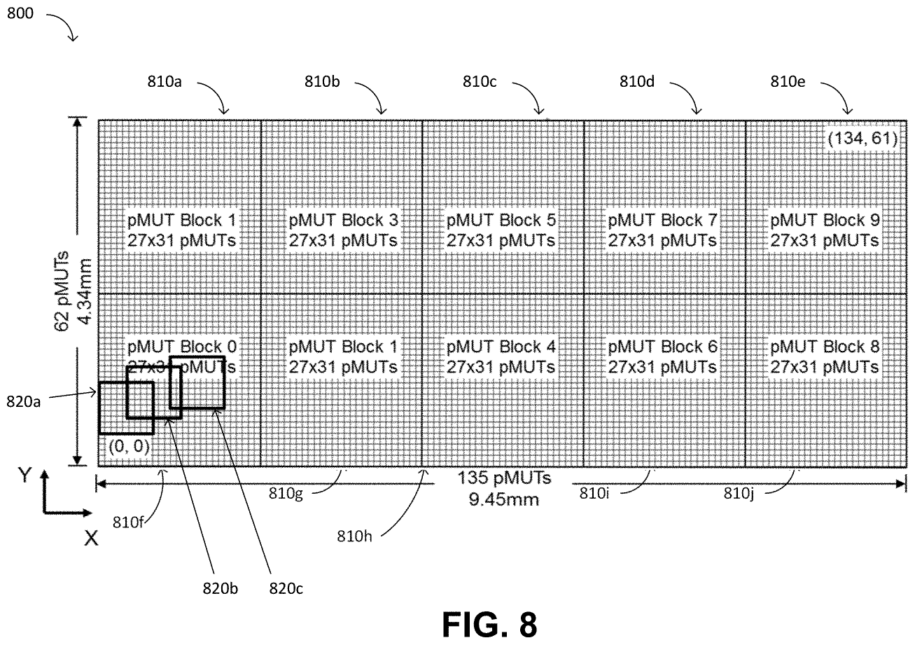

The ultrasonic sensor may comprise an array of ultrasonic transducer, these transducers may be PMUTs. FIG. 8 shows an example two-dimensional array 800 of ultrasonic transducers, distributed over ten blocks 810-j, according to embodiments. The ultrasonic sensor may use transmit beamforming using a phased subarray of transducers. As illustrated, each block 810-j includes 32×35 pixels. It should be appreciated that blocks in accordance with the described embodiments can include any number of ultrasonic transducers, and that the blocks can be any shape or size, and need not be square. For example, blocks may be rectangles including 25×25 ultrasonic transducers, 23×27 ultrasonic transducers, or any other arrangement of blocks and ultrasonic transducers. Moreover, in some embodiments, blocks can be non-quadrilateral (e.g., hexagon). It should be further appreciated that an ultrasonic sensor can include any number of blocks.

Two-dimensional array 800 (e.g., an ultrasonic sensor or an image sensor) is configured to capture an image. For example, an ultrasonic sensor may perform pixel capture by activating subsets of ultrasonic transducers for capturing single pixels (e.g., beam forming). During segmented image acquisition, multiple pixels are captured concurrently (e.g., one pixel is captured concurrently in each block). In some embodiments, one pixel is captured at a time per block. It should be appreciated that in some embodiments, more than one pixel may be captured at a time per block, dependent on the hardware configuration of the sensor.

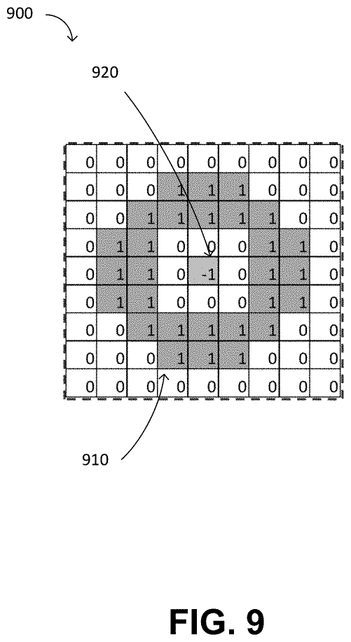

FIG. 9 shows an example 9×9 beamforming pattern 900, according to an embodiment. It should be appreciated that other sizes and shapes of transmit beam forming patterns may be used. Each square of beam forming pattern 900 identifies and is associated with an ultrasonic transducer, where a zero in the square indicates that no transmission is active in those transducers (e.g., the transducer is inactive), a one in the square indicates a transducer is active during transmission (illustrated as transmit beamforming pattern 910), and a negative one (−1) indicates that a transducer used to the receive reflected ultrasonic signals sent during transmission (illustrated as receive pattern 920). In accordance with some embodiments, some ultrasonic transducers of the transmit beam pattern are phase delayed with respect to other ultrasonic transducers of the transmit beam pattern to perform the transmit beamforming. This beamforming pattern may be scanned across the compete sensor surface to obtain an image (indicated by array positions 820a, 820b, and 820c of FIG. 8). This process may be performed simultaneous in the different blocks.

In the example of beamforming pattern 900, many transducers are used for transmitting (transmit beamforming pattern 910), and only a single transducer is used for receiving the reflected signals (receive pattern 920). In this simple example, no receive beamforming is performed. In one embodiment, to implement receive beam forming a subarray of transducers is used to receive the signal. The different obtained signals at the individual transducers are combined to perform receive beamforming. When performing receive beamforming in accordance with the described embodiments, multiple receive signal are combined to generate a pixel. While the signals are captured in sequence, the combination of the signals to generate a pixel accounts for a phase and/or time of flight difference between the signals.

For example, to perform the receive beamforming a slightly different time-of-flight (TOF) window is used for the different transducers, where the difference in TOF may be of the order of a nanosecond. The performance of the receive beamforming depends on the hardware capabilities, e.g., the capability to combine the different signals with small changes in the TOF windows. Alternatively, the transducers can be used to perform the receive beamforming, while the sensor employs other means to generate the ultrasonic waves. The generated waves may be plane waves. For example, a piezoelectric film, comprising PVDF, PZT, AlN or any other suitable material, may be used to generate a plane wave. The acoustic waves may also be generated external to the sensor, e.g. in an associated device. Furthermore, the transmit device may be positioned on the opposite side of the target so that the acoustic waves travel through the target.

In one embodiment, receive beamforming is performed using a pattern similar to beamforming pattern 900 of FIG. 9, as may be required due to hardware limitations. Each individual receive pattern does not incorporate beamforming, meaning within each pattern there is no combination of transducer signal with a different TOF window. Rather, the receive beamforming can be formed by combining signals from sequential acquisitions.

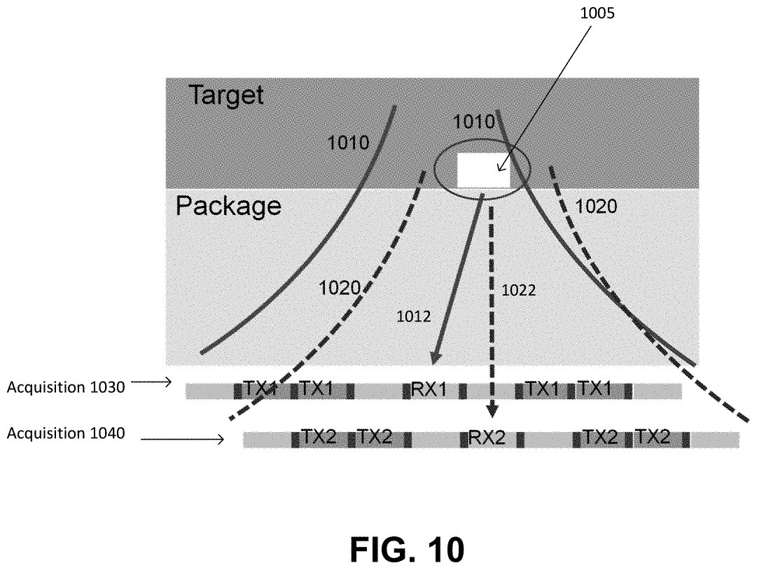

FIG. 10 shows a side view of an example of two sequential signal capture operations, according to embodiments. It should be appreciated that FIG. 10 shows a one-dimensional cross-section of a signal capture operation, which can be of a one-dimensional array of ultrasonic transducers or a two-dimensional array of ultrasonic transducers (e.g., the middle row or column of beamforming pattern 900 of FIG. 9). As illustrated, FIG. 10 shows an example of two sequential signal acquisitions 1030 and 1040, where acquisition 1040 performed by shifting the transmit/receive pattern one transducers to the right relative to acquisition 1030 (as explained in relation to FIGS. 7B and 8). As illustrated, TX represents the transmit ultrasonic transducers and RX represents the receive transducers, respectively. Lines 1010 represent the limits of the focused transmit beam during acquisition 1030, and lines 1020 represent the limits of the focused transmit beam during acquisition 1040. Region of interest 1005 represents the region of interest of the target being imaged. The width of the ultrasonic beam at the location of the region of interest 1005 is selected to be larger than region of interest 1005. As a result, when moving from acquisition 1030 to acquisition 1040, the regional pressure sonicating the region of interest remains the same and the receive transducer (e.g., reference array position). The transmit beam forming may be controlled to adjust the sonication of the target to enable the combination of the desired number/range of acquisitions.

As seen in FIG. 10, the angle of the signals 1012 and 1022 from the region of interest to the receive transducer changes between acquisition 1030 to acquisition 1040. Accordingly, signals 1012 and 1022 received from the different acquisitions can be used in a receive beam forming process. The signals 1012 and 1022 received from the different receive transducers can be combined taking into account the required phase/TOF difference to implement the receive beam forming. For example. This can be done be taking into consideration the geometry of the sensor and package, or can be determined in an optimization process considering a range of TOF/phases and determine the best image (e.g., sharpest image or image with most contrast). FIG. 10 shows an example of two sequential acquisition, but it should be appreciated that this principle may be applied to any number of acquisitions, sequential or otherwise. The limit of the array size is governed by the transmit beam forming and the sonication of the target. If the array becomes larger than the region of uniform sonication (e.g., imitating a plane wave), the receive beamforming performance decreases.

In accordance with various embodiments, the receive beamforming array may be one-dimensional, two-dimensional, or any desired size and shape. As an example, the receive beam forming array may be Uniform Rectangular Arrays (URA) and can be as small as (2×2) or as large as (9×9). The arrays may also be Uniform Linear Arrays (ULA) and can be as small as (1×2) or as large as (1×9). The size of the receive beam forming array may also influence the focal depth or aperture and consequently influences the sharpness of the resulting image. Therefore, defining the array size may depend on the focusing requirements of the ultrasound application at hand.

For example, an 3×3 or 5×5 receive beamforming array may be used. This means that the selected array is scanned over the larger transducers array, and the individual transducers signals within the receive beamforming array are combined with appropriate TOF delays and windows to perform the receive beam forming. Once receive beamforming array has been determined, conventional beamformers (such as delay-and-sum (DAS)) as well as adaptive beamformers (such as minimum-variance-distortionless-ratio (MVDR)) can be deployed to optimize the signal-to-noise ratio (SNR) and generate sharper images. It should be appreciated that in accordance with some embodiments, there are two stored arrays: one to store all the time of flight (TOF) and another array to store the processed/beamformed array, where each pixel is generated applying adjusted delay and an optimized amplitude weight on the several acquired individual transducers signals.

In accordance with various embodiments, the receive beamforming array size may be fixed, or may be adapted. For example, a larger size may result in a larger signal summation from different transducers and may increase SNR. However, the larger image size may lead to a loss of sharpness. Therefore, depending on the application the receive beamforming array size may be selected. When using the ultrasonic fingerprint sensor to image different layers of the skin, a smaller array size may be used for the outermost layer to maintain sharpness of the images. However, for deeper layers where less signal is received, a larger array size may be selected to increase SNR, at the cost of sharpness. The transmit beam forming may be adjusted to compensate for the loss of sharpness. For example, for the deeper layers the transmit beam forming can be adjusted for a deeper and larger region of sonification to match with the appropriate receive beam forming.

The receive beamforming array size may also depend on the location of the array within the larger sensor array. In one embodiment, to avoid edge effects at the edge of the sensor array, a smaller array size may be used at the edges, and a larger array size may be used away from the edges. For example, a 2D URA (3×3) may be used along the edges, and a larger URA (5×5) may be used away from the edges. Similarly, a 1D ULA (1×3) may be used along the edges, and a larger ULA (1×5) may be used away from the edges. Any combination of array sizes may be used depending on factors such as the desired sharpness and the influence of edge artifacts.

The choice of beamforming techniques may also influence the result and therefore may be selected based on the requirements. For example, utilization of conventional beamformers such as DAS beamformers results in sharper image generation as compared with adaptive beamformers such MVDR beamformers. The type of beamformer used may also depends on the selected window size. Also, of note is that changing the conventional beamforming methodologies, e.g. from DAS (conventional time domain beamformer) to phase shift (conventional frequency domain beamformer) will lead to similar SNR image gains.

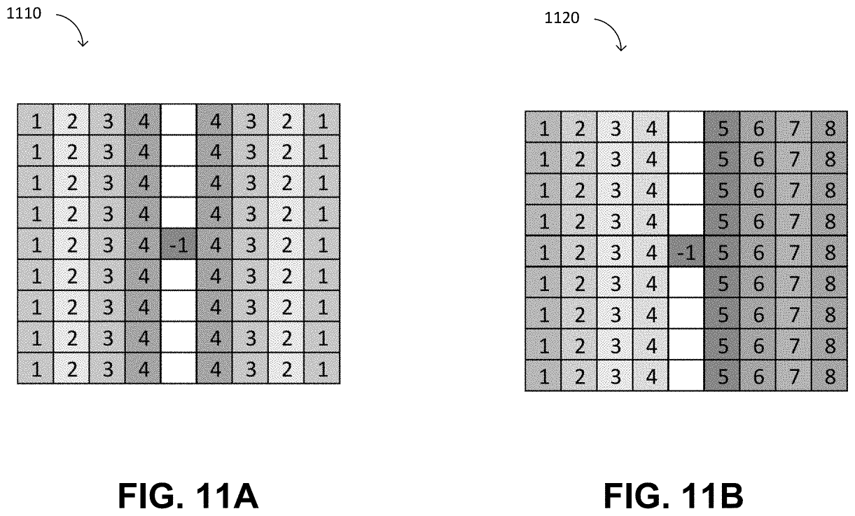

In accordance with some embodiments of the invention, multiple transmit beamforming pattern are used with the same receive transducer(s). In such embodiments, signal capture is performed multiple times at a same location of the array of ultrasonic transducers, where the transmit beamforming pattern is changed for each signal capture operation, while the receive pattern remains the same. FIGS. 11A and 11B show examples of different transmit beamforming patterns, according to embodiments. The transmit beamforming patterns of FIGS. 11A and 11B can be used in signal capture operations at a same position on the array, such that two signals captured responsive to different transmit beamforming patterns can be used to generate a combined signal or pixel.

FIG. 11A shows an example of a transmit beamforming pattern 1110, where numbers 1-4 represent transducers with different phase delay, and −1 indicates the receive transducer, according to an embodiment. In this example, one-dimensional beam forming is shown, but it should be appreciated that the same principle applies to a two-dimensional beamforming pattern. Transmit beamforming pattern 1110 produces a symmetric beam above the region of interest.

FIG. 11B shows an example of a transmit beamforming pattern 1120, where number 1-8 represent transducers with different phase delay, and −1 again indicates the same receive transducer. The shape of the beam has an asymmetric ultrasonic pressure compared to the region of interest, according to an embodiment.

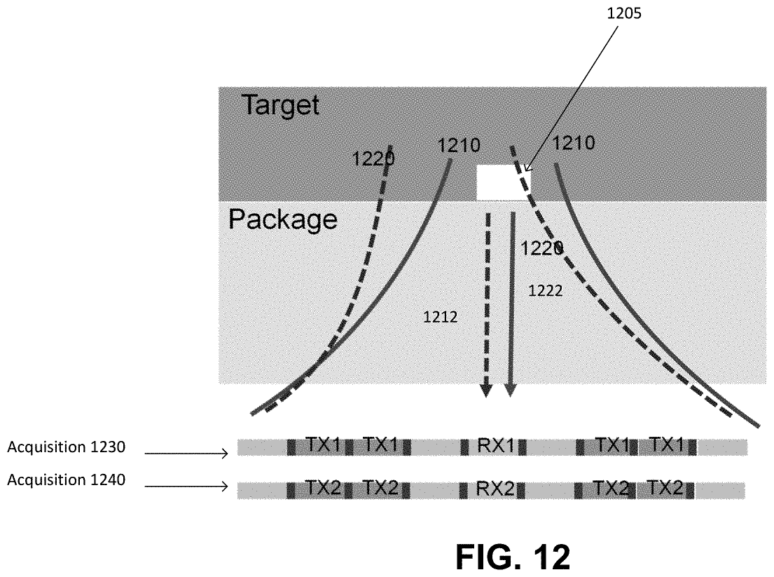

FIG. 12 shows a side view of an example of two sequential signal capture operations in which the transmit beamforming patterns is different for each signal capture operation, according to embodiments. It should be appreciated that FIG. 12 shows a one-dimensional cross-section of a signal capture operation, which can be of a one-dimensional array of ultrasonic transducers or a two-dimensional array of ultrasonic transducers. As illustrated, FIG. 12 shows an example of two sequential signal acquisitions 1230 and 1240, where acquisition 1240 performed by changing the transmit beamforming pattern relative to the transmit beamforming pattern used in acquisition 1230. For example, acquisition 1230 uses transmit beamforming pattern 1110 of FIG. 11A and acquisition 1240 uses transmit beamforming pattern 1120 of FIG. 11B. As illustrated, TX represents the transmit ultrasonic transducers and RX represents the receive transducers, respectively, where TX1 and RX1 are associated with acquisition 1230 and TX2 and RX 2 are associated with acquisition 1240. It should be appreciated that acquisitions 1230 and 1240 are performed at the same array position (e.g., reference array position) of the ultrasonic sensor.

Lines 1210 represent the limits of the focused transmit beam during acquisition 1230, and lines 1220 represent the limits of the focused transmit beam during acquisition 1240. Region of interest 1205 represents the region of interest of the target being imaged. The width of the ultrasonic beam at the location of the region of interest 1205 is selected to be larger than region of interest 1205. As a result, when moving from acquisition 1230 to acquisition 1240, the regional pressure sonicating the region of interest overlap (e.g., they might remain the same). The transmit beam forming may be controlled to adjust the sonication of the target to enable the combination of the desired number/range of acquisitions.

As seen in FIG. 12, the angle of the signals 1212 and 1222 from the region of interest 1205 to the receive transducer stays the same between acquisition 1230 and acquisition 1240. Accordingly, signals 1212 and 1222 received from the different acquisitions can be used in a receive beamforming process. For example, the acoustic path from the target to the RX transducer is the same, however, the TX beam pattern going to the target is different, which leads to TX beam angle and TOF differences. Therefore, there are differences in the full acoustic path. The signals 1212 and 1222 received at the same receive transducers can be combined. FIG. 12 shows an example of two sequential acquisition, but it should be appreciated that this principle may be applied to any number of acquisitions, sequential or otherwise. The limit of the array size is governed by the transmit beam forming and the sonication of the target. If the array becomes larger than the region of uniform sonication (e.g., imitating a plan wave), the receive beamforming performance decreases.

Signals 1212 and 1222 captured at the receive transducer can then be combined to generate a combined signal or pixel (e.g., to increase the SNR). It should be appreciated that similar receive beam forming techniques as described above can be applied during the combination to correct for phase difference and timing different between the signals created by the different beam shapes. The techniques of combining different transmit beam shapes may also be combined by the techniques acquiring the signal at different locations (e.g., as described in accordance with FIG. 10). When changing the transmit beamforming, the receive transducer(s) can remain unchanged (e.g., as shown in FIG. 12).

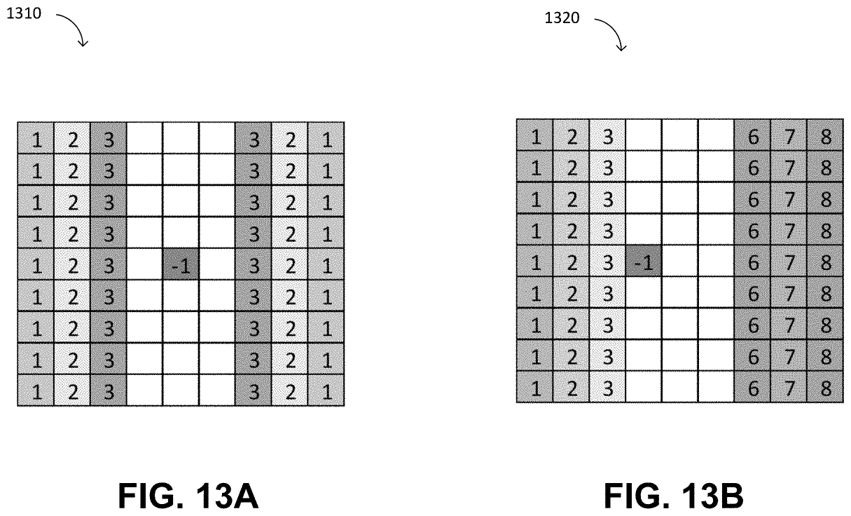

In accordance with some embodiments of the invention, multiple transmit beamforming pattern are used with different receive transducer(s). In such embodiments, signal capture is performed multiple times at a different location of the array of ultrasonic transducers, where the transmit beamforming pattern is also changed for each signal capture operation. FIGS. 13A and 13B show examples of different transmit beamforming patterns with different receive patterns, according to embodiments. The transmit beamforming patterns of FIGS. 13A and 138 can be used in signal capture operations at a same position on the array, such that two signals captured responsive to different transmit beamforming patterns can be used to generate a combined signal or pixel.

FIG. 13A shows an example of a transmit beamforming pattern 1310, where numbers 1-3 represent transducers with different phase delay, and −1 indicates the receive transducer, according to an embodiment. In this example, one-dimensional beam forming is shown, but it should be appreciated that the same principle applies to a two-dimensional beamforming pattern. Transmit beamforming pattern 1310 produces a symmetric beam above the region of interest.

FIG. 13B shows an example of a transmit beamforming pattern 1320, where number 1-3 and 6-8 represent transducers with different phase delay, and −1 a different receive transducer. The shape of the beam has an asymmetric ultrasonic pressure compared to the region of interest, according to an embodiment.

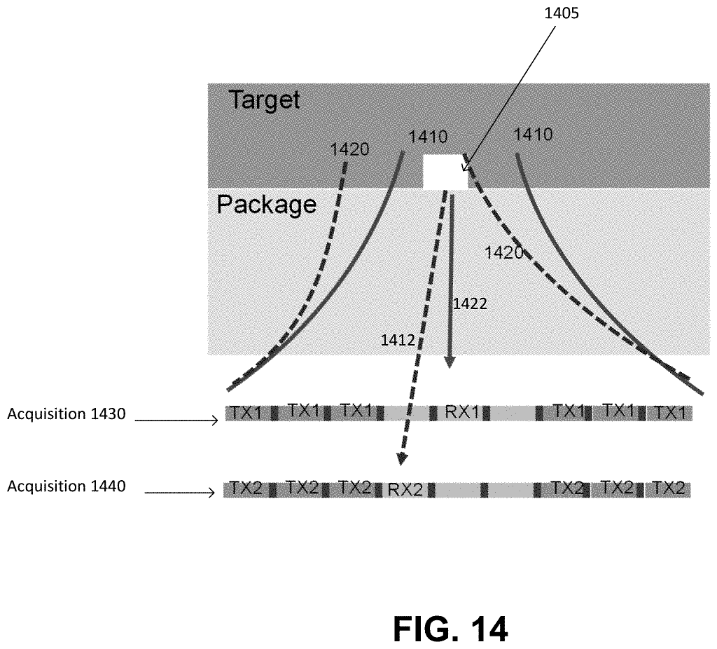

FIG. 14 shows a side view of an example of two sequential signal capture operations in which the transmit beamforming patterns and receive pattern is different for each signal capture operation, according to embodiments. It should be appreciated that FIG. 14 shows a one-dimensional cross-section of a signal capture operation, which can be of a one-dimensional array of ultrasonic transducers or a two-dimensional array of ultrasonic transducers. As illustrated, FIG. 14 shows an example of two sequential signal acquisitions 1430 and 1440, where acquisition 1440 performed by changing the transmit beamforming pattern and receive pattern relative to the transmit beamforming pattern and receive pattern used in acquisition 1430. For example, acquisition 1430 uses transmit beamforming pattern 1310 of FIG. 13A and acquisition 1440 uses transmit beamforming pattern 1320 of FIG. 13B. As illustrated, TX represents the transmit ultrasonic transducers and RX represents the receive transducers, respectively, where TX1 and RX1 are associated with acquisition 1430 and TX2 and RX2 are associated with acquisition 1440. It should be appreciated that acquisitions 1430 and 1440 are performed at different array positions of the ultrasonic sensor and that one of the array positions is selected as a reference array position.

Lines 1410 represent the limits of the focused transmit beam during acquisition 1430, and lines 1420 represent the limits of the focused transmit beam during acquisition 1440. Region of interest 1405 represents the region of interest of the target being imaged. The width of the ultrasonic beam at the location of the region of interest 1405 is selected to be larger than region of interest 1405. As a result, when moving from acquisition 1430 to acquisition 1440, the regional pressure sonicating the region of interest remains the same. The transmit beam forming may be controlled to adjust the sonication of the target to enable the combination of the desired number/range of acquisitions.

As seen in FIG. 14, the angle of the signals 1412 and 1422 from the region of interest 1405 to the receive transducer changes between acquisition 1430 and acquisition 1440. Accordingly, signals 1412 and 1422 received from the different acquisitions can be used in a receive beamforming process. The signals 1412 and 1422 received at the different receive transducers can be combined. FIG. 14 shows an example of two sequential acquisition, but it should be appreciated that this principle may be applied to any number of acquisitions, sequential or otherwise. The limit of the array size is governed by the transmit beam forming and the sonication of the target. If the array becomes larger than the region of uniform sonication (e.g., imitating a plan wave), the receive beamforming performance decreases.

Signals 1412 and 1422 captured at the receive transducer can then be combined to generate a combined signal or pixel (e.g., to increase the SNR). It should be appreciated that similar receive beam forming techniques as described above can be applied during the combination to correct for phase difference and timing different between the signals created by the different beam shapes. The techniques of combining different transmit beam shapes may also be combined by the techniques acquiring the signal at different locations (e.g., as described in accordance with FIG. 10). When changing the transmit beamforming, the receive transducer(s) can remain unchanged (e.g., as shown in FIG. 12).

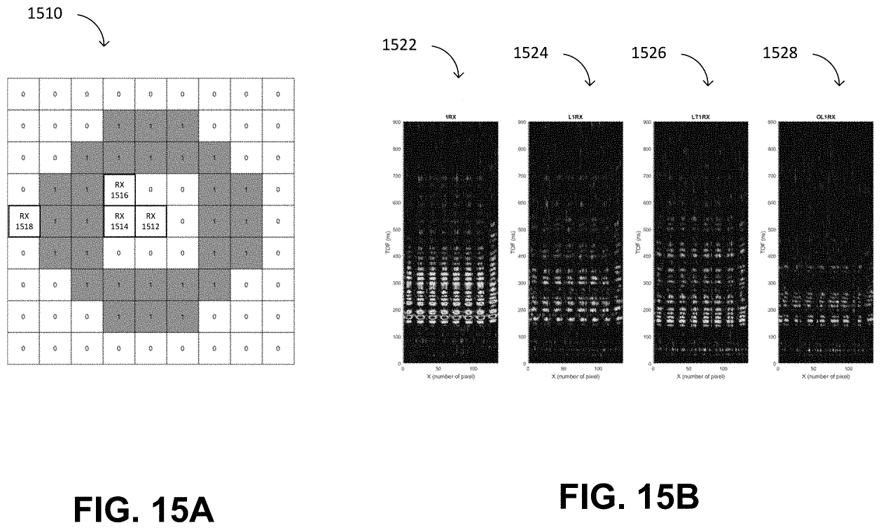

In one embodiment of the invention, the transmit beam form remains unchanged, but the position of the receive transducers may be varied within the array of transducers. FIG. 15A shows an example beamforming pattern 1510, where the transmit beamforming pattern stays unchanged and the receive pattern changes for different pixel capture operations. In beamforming pattern 1510, a zero in the square indicates that no transmission is active in those transducers (e.g., the transducer is inactive), a one in the square indicates a transducer is active during transmission, and transducers 1512, 1514, 1516, and 1518 are each active in separate and different pixel capture operations. Beamforming pattern 1510 is used to perform four different pixel capture operations, where the transmit beamforming pattern does not change during the pixel capture operations, while different transducers 1512, 1514, 1516, and 1518 are active in each different pixel capture operations. It should be appreciated that beamforming pattern 1510 can be used in pixel capture operations in accordance with the described embodiments.

FIG. 15B shows example plots 1522, 1524, 1526, and 1528 of signals received from an example line phantom target using the different receive transducers of FIG. 15A, according to embodiments. Each plot 1522, 1524, 1526, and 1528 shows a line of transducers on the x-axis, and the TOF along the y-axis. As illustrated, plot 1522 corresponds to signals received at transducer 1512 of beamforming pattern 1510, plot 1524 corresponds to signals received at transducer 1514 of beamforming pattern 1510, plot 1526 corresponds to signals received at transducer 1516 of beamforming pattern 1510, and plot 1528 corresponds to signals received at transducer 1518 of beamforming pattern 1510.

Each plot 1522, 1524, 1526, and 1528 shows the primary reflected signals around 150 ns, and signals caused by multipath reflections for TOF>200 ns. Because of the different locations of the receive transducer compared to the transmit beam, the characteristics of the received ultrasonic waves differs (e.g., incident angle). This leads to slight changes in the receive timing. In accordance with embodiments, the signals received at transducers 1512, 1514, 1516, and 1518 are combined to generate a combined signal or pixel. A correction for the timing difference is performed during the receive beamforming when the different signals are combined to account for the timing difference.

Furthermore, the multipath reflections have different paths and thus a different distribution over time. This characteristic can be used to differentiate between the primary signal and multipath signal and can help reduce the multipath signal contributions. For example, the different plots 1522, 1524, 1526, and 1528 show a large correlation between the primary signal and a reduced correlation between the multipath signals. Therefore, based on the signal correlation at the different receive location, it can be determined if the signal is a multipath signal. If the correlation is low, the signal contribution is reduced. For example, the correlation can be investigated over a TOF window with a certain width, and this window can be moved over the complete TOF range of interest.

### Example Operations for Receive Beamforming at an Ultrasonic Sensor

FIGS. 16, 17, and 18 illustrate flow diagrams of example methods for selection and use of pixel capture sequences during segmented image acquisition, according to various embodiments. Procedures of these methods will be described with reference to elements and/or components of various figures described herein. It is appreciated that in some embodiments, the procedures may be performed in a different order than described, that some of the described procedures may not be performed, and/or that one or more additional procedures to those described may be performed. The flow diagrams include some procedures that, in various embodiments, are carried out by one or more processors (e.g., a host processor or a sensor processor) under the control of computer-readable and computer-executable instructions that are stored on non-transitory computer-readable storage media. It is further appreciated that one or more procedures described in the flow diagrams may be implemented in hardware, or a combination of hardware with firmware and/or software.

FIG. 16 illustrates a flow diagram 1600 of an example process for receive beamforming using an array of ultrasonic transducers where one pixel capture operation over the array is performed, according to embodiments. At procedure 1610 of flow diagram 1600, a plurality of array positions comprising pluralities of ultrasonic transducers of the array of ultrasonic transducers is defined, the plurality of array positions each comprising a portion of ultrasonic transducers of the array of ultrasonic transducers.

At procedure 1620, a pixel capture operation is performed at each array position of the plurality of array positions. As shown at procedure 1622, ultrasonic signals are transmitted using a transmit beam pattern comprising ultrasonic transducers of the array of ultrasonic transducers, wherein at least some ultrasonic transducers of the transmit beam pattern are phase delayed with respect to other ultrasonic transducers of the transmit beam pattern, the transmit beam pattern for forming an ultrasonic beam toward a region of interest. At procedure 1624, ultrasonic signals are received using a receive beam pattern comprising at least one ultrasonic transducer of the array of ultrasonic transducers, wherein the transmit beam pattern comprises different ultrasonic transducers than the receive beam pattern.

At procedure 1630, received reflected ultrasonic signals are combined for a plurality of array positions overlapping the region of interest in a receive beamforming operation to generate a pixel for a reference array position of the plurality of array positions. In one embodiment, the plurality of array positions overlapping the region of interest comprises a plurality of sequential array positions of the pixel capture operation. In one embodiment, as shown at procedure 1632, a difference in time of flight of the received reflected ultrasonic signals for the plurality of array positions overlapping the region of interest is accounted for. In one embodiment, as shown at procedure 1634, a difference in phase the received reflected ultrasonic signals for the plurality of array positions overlapping the region of interest is accounted for. In one embodiment, the reference array position is center array position of the plurality of array positions overlapping the region of interest.

In one embodiment, as shown at procedure 1640, an image comprising the pixels at each array position of the plurality of array positions is generated.

FIG. 17 illustrates a flow diagram 1700 of an example process for receive beamforming using an array of ultrasonic transducers where a plurality of pixel capture operations over the array is performed, where the plurality of pixel capture operations is performed at each array position changing at least one of the transmit beam pattern and the receive beam pattern prior to proceeding to a subsequent array position, according to embodiments. At procedure 1710 of flow diagram 1700, a plurality of array positions comprising pluralities of ultrasonic transducers of the array of ultrasonic transducers is defined, the plurality of array positions each comprising a portion of ultrasonic transducers of the array of ultrasonic transducers.

At procedure 1720, a pixel capture operation is performed at each array position of the plurality of array positions. As shown at procedure 1722, ultrasonic signals are transmitted using a transmit beam pattern comprising ultrasonic transducers of the array of ultrasonic transducers, wherein at least some ultrasonic transducers of the transmit beam pattern are phase delayed with respect to other ultrasonic transducers of the transmit beam pattern, the transmit beam pattern for forming an ultrasonic beam toward a region of interest. At procedure 1724, ultrasonic signals are received using a receive beam pattern comprising at least one ultrasonic transducer of the array of ultrasonic transducers, wherein the transmit beam pattern comprises different ultrasonic transducers than the receive beam pattern.

At procedure 1730, it is determined whether there are more signals to capture at an array position. Provided it is determined that there are more signals to capture at an array position, as shown at procedure 1740, at least one of the transmit beam pattern and the receive pattern are changed, and flow diagram 1700 proceeds to procedure 1722. Provided it is determined that there are no more signals to capture at an array position, flow diagram 1700 proceeds to procedure 1750.

At procedure 1750, it is determined whether there are more array positions in which to perform a pixel capture operation. Provided it is determined that there are more array positions in which to perform a pixel capture operation, as shown at procedure 1760, the pixel capture operation moves to the next array position, and flow diagram 1700 proceeds to procedure 1722. Provided it is determined that there are no more array positions in which to perform a pixel capture operation, flow diagram 1700 proceeds to procedure 1770.

At procedure 1770, received reflected ultrasonic signals are combined for a plurality of array positions overlapping the region of interest in a receive beamforming operation to generate a pixel for a reference array position of the plurality of array positions. In one embodiment, the reference array position is center array position of the plurality of array positions overlapping the region of interest. In one embodiment, as shown at procedure 1780, an image comprising the pixels at each array position of the plurality of array positions is generated.

FIG. 18 illustrates a flow diagram 1800 of an example process for receive beamforming using an array of ultrasonic transducers where one pixel capture operation over the array is performed, wherein each pixel capture operation is performed over the array of ultrasonic transducers prior to changing at least one of the transmit beam pattern and the receive beam pattern, according to embodiments. At procedure 1810 of flow diagram 1800, a plurality of array positions comprising pluralities of ultrasonic transducers of the array of ultrasonic transducers is defined, the plurality of array positions each comprising a portion of ultrasonic transducers of the array of ultrasonic transducers.

At procedure 1820, a pixel capture operation is performed at each array position of the plurality of array positions. As shown at procedure 1822, ultrasonic signals are transmitted using a transmit beam pattern comprising ultrasonic transducers of the array of ultrasonic transducers, wherein at least some ultrasonic transducers of the transmit beam pattern are phase delayed with respect to other ultrasonic transducers of the transmit beam pattern, the transmit beam pattern for forming an ultrasonic beam toward a region of interest. At procedure 1824, ultrasonic signals are received using a receive beam pattern comprising at least one ultrasonic transducer of the array of ultrasonic transducers, wherein the transmit beam pattern comprises different ultrasonic transducers than the receive beam pattern.

At procedure 1830, it is determined whether there are more pixel capture operations to perform. Provided it is determined that there are more pixel capture operations to perform, as shown at procedure 1840, at least one of the transmit beam pattern and the receive pattern are changed, and flow diagram 1800 proceeds to procedure 1822. Provided it is determined that there are no more pixel capture operations to perform, flow diagram 1800 proceeds to procedure 1850.

At procedure 1850, received reflected ultrasonic signals are combined for a plurality of array positions overlapping the region of interest in a receive beamforming operation to generate a pixel for a reference array position of the plurality of array positions. In one embodiment, the reference array position is center array position of the plurality of array positions overlapping the region of interest. In one embodiment, as shown at procedure 1860, an image comprising the pixels at each array position of the plurality of array positions is generated.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A method for receive beamforming using an array of ultrasonic transducers, the method comprising:
defining a plurality of array positions comprising pluralities of ultrasonic transducers of the array of ultrasonic transducers, the plurality of array positions each comprising a portion of ultrasonic transducers of the array of ultrasonic transducers;
performing a pixel capture operation at each array position of the plurality of array positions, the pixel capture operation comprising:
transmitting ultrasonic signals using a transmit beam pattern comprising ultrasonic transducers of the array of ultrasonic transducers, wherein at least some ultrasonic transducers of the transmit beam pattern are phase delayed with respect to other ultrasonic transducers of the transmit beam pattern, the transmit beam pattern for forming an ultrasonic beam toward a region of interest; and
receiving reflected ultrasonic signals using a receive beam pattern comprising at least one ultrasonic transducer of the array of ultrasonic transducers, wherein the transmit beam pattern comprises different ultrasonic transducers than the receive beam pattern; and
combining received reflected ultrasonic signals for a plurality of array positions overlapping the region of interest in a receive beamforming operation to generate a pixel for a reference array position of the plurality of array positions.

2. The method of claim 1, wherein the combining received reflected ultrasonic signals for a plurality of array positions overlapping the region of interest in a receive beamforming operation to generate a pixel for the region of interest comprises:
accounting for a difference in time of flight of the received reflected ultrasonic signals for the plurality of array positions overlapping the region of interest.

3. The method of claim 1, wherein the combining received reflected ultrasonic signals for a plurality of array positions overlapping the region of interest in a receive beamforming operation to generate a pixel for the region of interest comprises:
accounting for a difference in phase of the received reflected ultrasonic signals for the plurality of array positions overlapping the region of interest.

4. The method of claim 1, wherein the plurality of array positions overlapping the region of interest comprises a plurality of sequential array positions of the pixel capture operation.

5. The method of claim 1, wherein a plurality of pixel capture operations are performed at each array position of the plurality of array positions.

6. The method of claim 5, wherein at least one of the transmit beam pattern and the receive beam pattern is changed over the plurality of pixel capture operations at each array position.

7. The method of claim 6, further comprising:
changing ultrasonic transducers of the transmit beam pattern over the plurality of pixel capture operations at each array position.

8. The method of claim 6, further comprising:
changing ultrasonic transducers of the receive beam pattern over the plurality of pixel capture operations at each array position.

9. The method of claim 6, wherein the plurality of pixel capture operations is performed at each array position changing at least one of the transmit beam pattern and the receive beam pattern prior to proceeding to a subsequent array position.

10. The method of claim 6, wherein each pixel capture operation is performed over the array of ultrasonic transducers prior to changing at least one of the transmit beam pattern and the receive beam pattern.

11. The method of claim 1, further comprising:
generating an image comprising the pixels at each array position of the plurality of array positions.

12. The method of claim 1, wherein the reference array position is center array position of the plurality of array positions overlapping the region of interest.

13. An ultrasonic sensor device comprising:
an array of ultrasonic transducers; and
a processor, wherein the processor is configured to:
define a plurality of array positions comprising pluralities of ultrasonic transducers of the array of ultrasonic transducers, the plurality of array positions each comprising a portion of ultrasonic transducers of the array of ultrasonic transducers;
perform a pixel capture operation at each array position of the plurality of array positions, the pixel capture operation configured to:
transmit ultrasonic signals using a transmit beam pattern comprising ultrasonic transducers of the array of ultrasonic transducers, wherein at least some ultrasonic transducers of the transmit beam pattern are phase delayed with respect to other ultrasonic transducers of the transmit beam pattern, the transmit beam pattern for forming an ultrasonic beam toward a region of interest; and
receive reflected ultrasonic signals using a receive beam pattern comprising at least one ultrasonic transducer of the array of ultrasonic transducers, wherein the transmit beam pattern comprises different ultrasonic transducers than the receive beam pattern; and
combine received reflected ultrasonic signals for a plurality of array positions overlapping the region of interest in a receive beamforming operation to generate a pixel for a reference array position of the plurality of array positions.

14. The ultrasonic sensor device of claim 13, wherein the processor is further configured to:
account for a difference in time of flight of the received reflected ultrasonic signals for the plurality of array positions overlapping the region of interest.

15. The ultrasonic sensor device of claim 13, wherein the processor is further configured to:
account for a difference in phase of the received reflected ultrasonic signals for the plurality of array positions overlapping the region of interest.

16. The ultrasonic sensor device of claim 13, wherein a plurality of pixel capture operations are performed at each array position of the plurality of array positions.

17. The ultrasonic sensor device of claim 16, wherein at least one of the transmit beam pattern and the receive beam pattern is changed over the plurality of pixel capture operations at each array position.

18. The ultrasonic sensor device of claim 16, wherein the processor is further configured to:
change ultrasonic transducers of the transmit beam pattern over the plurality of pixel capture operations at each array position.

19. The ultrasonic sensor device of claim 16, wherein the processor is further configured to:
change ultrasonic transducers of the receive beam pattern over the plurality of pixel capture operations at each array position.

20. A non-transitory computer readable storage medium having computer readable program code stored thereon for causing a computer system to perform a method for receive beamforming using an array of ultrasonic transducers, the method comprising:
defining a plurality of array positions comprising pluralities of ultrasonic transducers of the array of ultrasonic transducers, the plurality of array positions each comprising a portion of ultrasonic transducers of the array of ultrasonic transducers;
performing a pixel capture operation at each array position of the plurality of array positions, the pixel capture operation comprising:
transmitting ultrasonic signals using a transmit beam pattern comprising ultrasonic transducers of the array of ultrasonic transducers, wherein at least some ultrasonic transducers of the transmit beam pattern are phase delayed with respect to other ultrasonic transducers of the transmit beam pattern, the transmit beam pattern for forming an ultrasonic beam toward a region of interest; and
receiving reflected ultrasonic signals using a receive beam pattern comprising at least one ultrasonic transducer of the array of ultrasonic transducers, wherein the transmit beam pattern comprises different ultrasonic transducers than the receive beam pattern; and
combining received reflected ultrasonic signals for a plurality of array positions overlapping the region of interest in a receive beamforming operation to generate a pixel for a reference array position of the plurality of array positions.
